(19) United States
(12) Patent Application Publication
(10) Pub. No.: US 2025/0042232 A1
(43) Pub. Date: Feb. 6, 2025

(54) VEHICLE COVER

(71) Applicant: James C. Jensen, Naples, FL (US)

(72) Inventor: James C. Jensen, Naples, FL (US)

(73) Assignee: Flood Vault, LLC, Naples, FL (US)

(21) Appl. No.: 18/228,071

(22) Filed: Jul. 31, 2023

(51) Int. Cl. B60J 11/04

(52) U.S. Cl. CPC B60J 11/04

(57) ABSTRACT

A vehicle cover including a flexible enclosure attached to a base. The vehicle can be driven onto the base, and the enclosure can then be draped over the vehicle, and fastened to the base, so that the vehicle cover completely encapsulates the vehicle in a waterproof and hermetically sealed manner.

### BACKGROUND OF THE INVENTION

The present invention generally relates to vehicle covers and, more specifically, to waterproof vehicle covers useful to combat storms, flooding and storm surges.

Covers to protect vehicles during storm surges and to combat flooding are known. Known vehicle covers suffer from various disadvantages, including but not limited to: only covering/protecting an upper portion of the vehicle; not being waterproof; and not being sufficiently durable and/or easy to use. Prior vehicle covers also fail to address the problems inherent in damage to the vehicle when the vehicle is allowed to float during storm surge and/or flooding situations.

Accordingly, there is a need fora vehicle cover which overcomes these disadvantage, while minimizing the damage to the vehicle from its flotational movement.

### Definition of Claim Terms

The terms used in the claims of the patent are intended to have their broadest meaning consistent with the requirements of law. Where alternative meanings are possible, the broadest meaning is intended. All words used in the claims are intended to be used in the normal, customary usage of grammar and the English language.

### SUMMARY OF THE INVENTION

The objects mentioned above, as well as other objects, are solved by the present invention, which overcomes disadvantages of prior vehicle covers, while providing new advantages not previously associated with them. This summary is provided to introduce a selection of concepts in a simplified form that are further described below in the Detailed Description, so that the claimed invention may be better understood. However, this summary is not intended to limit the scope of the claimed subject matter.

In one preferred embodiment of the present invention, a method is provided for using a vehicle cover, and includes the steps of: providing a base; providing a flexible enclosure attached to the base; driving the vehicle onto the base, wherein the base is sufficiently durable to be driven upon by the vehicle without the base tearing or puncturing (at least until after a certain acceptable predetermined usages of the base); covering an upper portion of the vehicle with the flexible enclosure; and completely encapsulating the vehicle in a waterproof manner within the base and the enclosure, by hermetically sealing the enclosure to the base.

In one preferred embodiment of the invention, the enclosure and the base are hermetically sealed together using a waterproof zipper that results in the vehicle being hermetically sealed within the cover. A protective flap may be used to protect the zipper, which may be plastic or metal, and/or to protect the cover and the enclosure from being damaged by the waterproof zipper. In an alternative embodiment, a magnetic fastening system may be used to provide the waterproof, hermetic seal between the base and the enclosure.

In preferred embodiments, the base and the enclosure are each made of plastic or fabric. Woven fabric, such as nylon or synthetic woven fabric such as polyester, may be preferred. One particularly preferred fabric is nylon coated on one side, or both sides, with a thermoplastic such as polyurethane. Another preferred fabric is woven polyester scrim.

In one preferred example, at least a portion of the vehicle is covered with a second enclosure, positioned below the vehicle cover, for at least partially covering the vehicle and thereby protecting vehicle paint during encapsulation of the vehicle within the vehicle cover.

In another preferred example, the enclosure or the base, or both, may include one or more one-way air vents, used to remove air from a working volume between the vehicle and the cover, after the vehicle has been hermetically sealed within the cover, to achieve a relatively slight negative vacuum, compared to atmosphere, within the working volume, thereby reducing the buoyancy of the vehicle.

Preferably, the enclosure is capable of holding a positive pressure of air within the working volume for at least about 5 minutes.

In a preferred example, the base is relatively strong and has a tensile strength of greater than about 200 pounds/inch in both warp and weft directions. The enclosure, while not as strong as the base, is still relatively strong and may have a tensile strength of greater than about 100 pounds/inch in both warp and weft directions.

The vehicle over is preferably relatively light. For example, the total weight of the vehicle cover is preferably about or less than fifty pounds, and most preferably about or less than forty pounds. For example, the total weight of the vehicle cover may be in the range of about 30-50 pounds, such as about 30-40 pounds. In one preferred example, the weight of the base is about equal to or less than about 20 ounces/yard², while the weight of the enclosure is about equal to or less than about 2 ounces/yard².

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a planar perspective view of a preferred embodiment of the vehicle cover of the present invention, in an open position, with a vehicle being driven upon the base;

FIG. 2 is a view similar to FIG. 1, showing the vehicle fully encompassed by the base, with the top of the cover in the act of being folded over the vehicle;

FIG. 3 is a view similar to FIG. 1, showing the vehicle fully enclosed by the vehicle cover;

FIG. 4 is a sectional view along reference lines 4-4 of FIG. 3, showing the base and the upper enclosure sealed together by a waterproof zipper;

FIG. 5 is a front view of the vehicle cover of FIG. 1, showing the sealed vehicle;

FIG. 6 is a top view of the vehicle cover of FIG. 1, in the open position;

FIGS. 7A-7D are schematic drawings showing side, front, planar and top views, respectively, of another embodiment of the present invention; and

FIG. 8 is a side view of the vehicle cover enclosing a vehicle.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

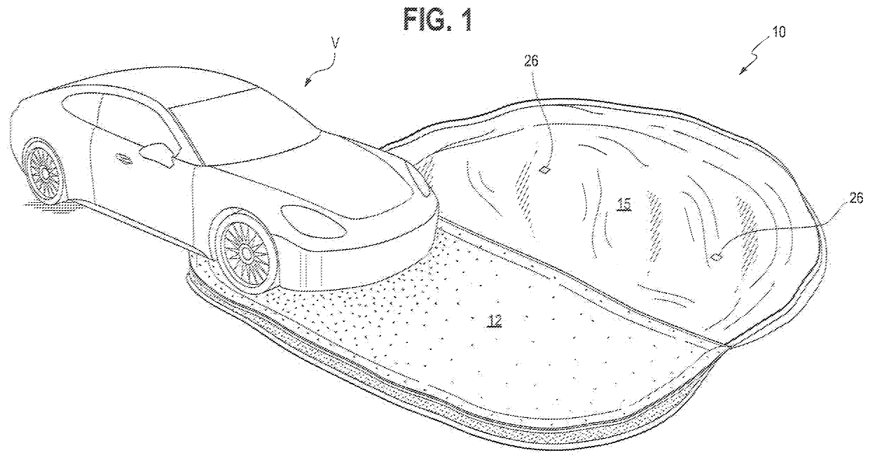

Referring first to FIG. 1, a preferred embodiment of the vehicle cover of the present invention is shown, denoted by the reference numeral 10. Vehicle cover 10 includes a base 12 and a flexible enclosure 15. Base 12 and enclosure 15 may be flexibly attached by any expedient means, including hook-and-loop, buttons, zippers, etc. It is preferred that the attachment be waterproof in nature.

Base 12 and enclosure 15 may be attached relative to each other in any expedient manner. In the preferred embodiment, a “clamshell” attachment is utilized, like opening a book. Persons of ordinary skill in the art will understand that various other ways of attaching the base to the enclosure may be envisioned and utilized.

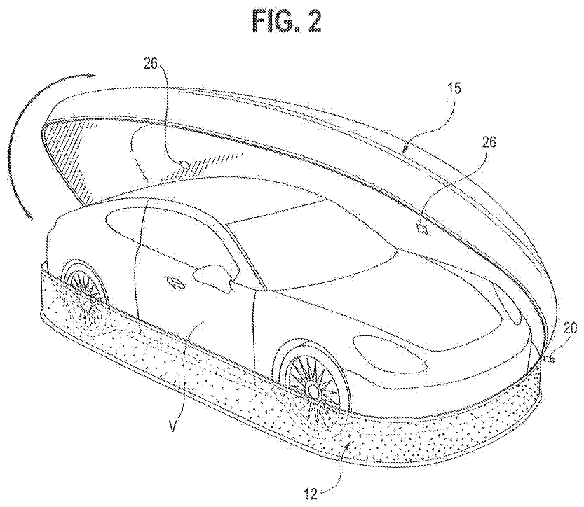

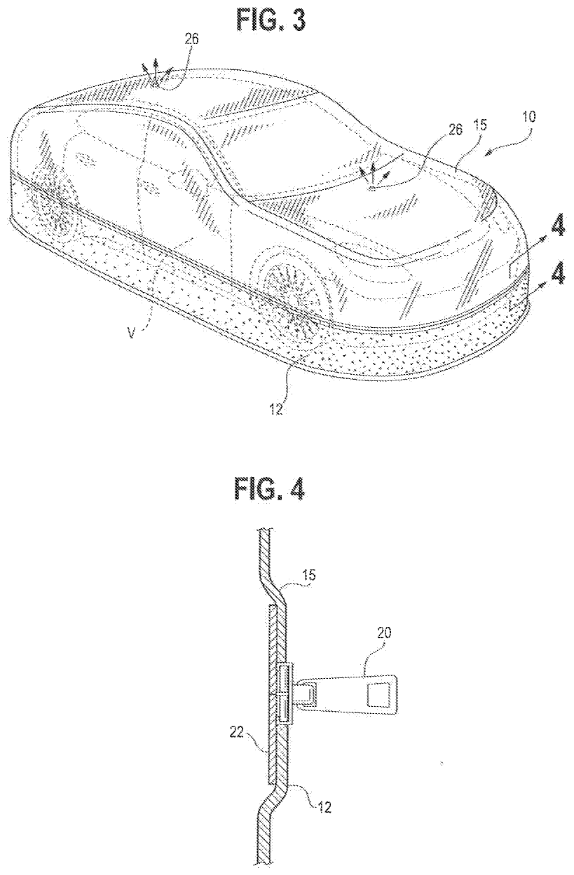

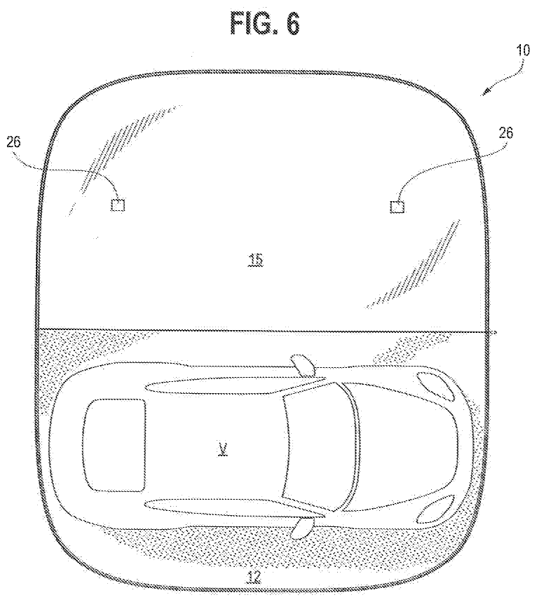

Still referring to FIG. 1, vehicle V may be driven onto base 12 until fully within the perimeter of the base, as shown at FIG. 6. Now, referring to FIG. 2, enclosure 15 may be pulled over the vehicle and enclosure 15 and base 12 may be zippered together, preferably using waterproof zipper 20, so that the vehicle is fully sealed in a waterproof manner, as shown in FIGS. 3-4, such that the vehicle is an airtight, hermetic seal within the cover. The zipper employed may be similar to zippers used to seal a wet suit, and a protective flap 22 may be used (which may, for example, be attached to the base) to ensure that the act of zippering does not damage either the base or the enclosure.

When a vehicle floats about its centroid, it tends to tilt down, and the lowermost surface will bounce and scrape along the bottom, damaging the vehicle in the process. To limit vehicle damage in a storm surge or flooding situation, it is best if the vehicle is not allowed to float.

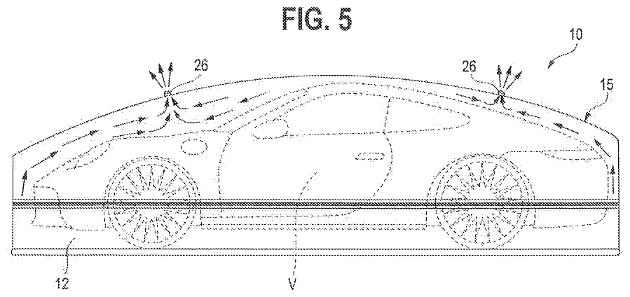

Referring now to FIGS. 3 and 5, once the vehicle is fully sealed within vehicle cover 10, air may be removed from the area outside the vehicle, and inside the cover, using one or more one-way air valves 26. This will decrease the tendency of the vehicle to float if it is submerged in water. Air valve(s) 26 are preferably located relatively near the ground, where they can be conveniently reached by a vacuum tube for using in removing air from the area encapsulated by vehicle cover 10 (i.e., the hermetically sealed area between the vehicle and the cover itself). Preferably, the pressurized air in this area is left with a slight negative vacuum, so that the enclosure sticks to or closely envelopes the vehicle.

A one-way air valve (air vent lock) that may be used is the Oralmatic™ tube end valve (Drawing No. C730ROA; https://www.halkeyroberts.com/Products/720ROA-Oralmatic%E2%84%A2-tube-end-relief-valve) available from Halkey-Roberts® of St. Petersburg, Florida. The Oralmatic™ II has a body of anodized aluminum, a stem of brass and silicon, a stainless steel spring, and a polypropylene poppet; the opening pressure is 0.03-0.6 psig, and may be inserted directly into oral tubes. With this particular product, the leak rate is less than about 10 psig, and the crack pressure is 0.44 psig.

One preferred material that may be used for base 12 is available from Erez Thermoplastic Products, Kibbutz Erez, M.P. Ashkelon Coast, Israel (“Erez”), and known as TPU 2003. TPU 2003 is a Nylon fabric with a membrane coated with TPU on both sides, and is used to make inflatable life rafts, for example. The specifications for TPU 2003 are as follows:

TPU both sides coated membrane, Nylon fabric.
End Use: Inflatable liferafts for manufacturing: Buoyancy tubes, inflatable supports for canopies and double/single bottom floors, Oil booms.
Compliance with: MSC 70/23 Add. 1—IMO Resolution MSC.81 (70) Annex 6, Section: 5.17.13.2.2.1.÷5.17.13.2.2.12—LEV3/MSEP(c)/LSA.INS. VOL2/REV-AOOO/Page 209 of 311 (Marine Safety Agency—Department of Transport). Inflatable boats ISO 6185

Spec.

| Para. | Properties | Requirements | | Results | |
|---|---|---|---|---|---|
| 7. | Base Fabric, Type | — | | Nylon | |
| 7.1 | Base Fabric, dtex | — | | 940 | dtx |
| — | Total Weight | — | | 680 | gr/m² |
| — | Width[s]**** | — | | 150, 205 | [cm] |
| 21.1(I) | Tensile Strength - Kgf/ | 230 | min | 275 | |
| | 50 mm width - Warp | | | | |
| | Tensile Strength - Kgf/ | 225 | min | 250 | |
| | 50 mm width - Warp | | | | |
| | Elongation at 225 - Kgf/ | 30 | max | 20 | |
| | 50 mm - % Warp | | | | |
| | Elongation at 225 - Kgf/ | 30 | max | 25 | |
| | 50 mm - % Warp | | | | |
| 21.1(II) | Tear Strength - Kgf - | 105 | | 120 | |
| | warp | | | | |
| | Tear Strength - Kgf - | 105 | | 110 | |
| | weft | | | | |
| 21.1(III) | Surface Receptiveness - | 7.5 | min. | 20/20 | |
| | Kgf/50 mm | | | | |
| | Coating Adhesion- Dry - | Max. 5 mm | | Pass | |
| | 7.5 Kgf/50 mm - 5 min. | separation | | | |
| | Wet - 5.0 Kgf/50 mm - 5 | Max. 5 mm | | Pass | |
| | minutes | separation | | | |
| | (Wet - 24 hours in 3% | | | | |
| | Aqueous Sodium | | | | |
| | Chloride) | | | | |
| 21.1(IV) | Effects of Ageing | No Cracks, | | Complies | |
| | (i) in air at 70° C. ± | separation | | Pass | |
| | 2° C. for 7 days | 90 | min | | |
| | (ii) suspended over water | | | | |
| | for 7 days at 70° C. ± | | | | |
| | 2° C. | | | | |
| | Folding test, after (i) & | | | | |
| | (ii) | | | | |
| | Tensile Str. - % of | | | | |
| | original, after (i) & (ii) | | | | |
| 21.1(V) | Dimensional stability - | 2 | max. | 0.7/1.2 | |
| | %, after (i) & (ii) | | | | |
| 21.1(VI) | Low Temperature - | No Cracks | | Pass | |
| | 50° C. | | | | |
| 21.1(VII) | Flex Cracking - 200,000 | No Cracks or | | Pass | |
| | cycles* | Delamination | | | |
| | (After soaking for 7 days | | | | |
| | in 2% solution of brine) | | | | |
| 21.1(VIII) | Porosity at 4 psi | No leakage | | Pass | |
| | | at 5 minutes | | | |
| 21.1(IX) | Oil resistance - ASTM | No Smear, | | Pass | |
| | No. 1 (2 hours) ** | Separation, | | | |
| | 20° C. | Tackiness | | | |
| 21.1(X) | Weight variation - % of | ±10 | max. | ±8 | |
| | spec. | | | | |
| 21.1(XI) | Weft Distortion - mm | 100 | max. | 50 | |
| 21.1(XII) | Blocking - Lifting force - | 100 | max | Pass | |
| | gmf | | | | |
| 21.1(VIII) | Weld Strength - Kg per | 18 | min. | 27 | |
| | 25 mm width | | | | |
| 21.1(XIV) | Hydrolysis Resist. - | 5.0 | min. | 16 | |
| | Coating Adhesion - | | | | |
| | Kg/50 mm | | | | |
| | Blocking - gmf | 100 | max. | Pass | |
| | Weld Strength - | 12.5 | min. | 18 | |
| | Kg/25 mm | | | | |
| | Folding Test | No Cracking, | | Pass | |
| | (12 weeks over water in | delamination | | | |
| | closed contained at | | | | |
| | 93° C.) | | | | |

| | | | |
|---|---|---|---|
| 21.1(XV) | Ozone Resistance** | No Cracks | Pass |
| | Abrasion Resistance | >10,000 | >10,000 |
| | (Taber H-22 Wheel | cycles to | cycles to |
| | 1 Kg load) | expose the | expose the |
| | ASTM D 3389 | fabric | fabric |

As one example, if the tensile strength for TPU 2003 is about 200 kg/50 mm width of a material sample, this converts to about 224 pounds/inch of tensile strength.

One preferred material that may be used for enclosure 15 is also available from Erez, and is known as TPU 2012. The specifications for TPU 2012 are as follows:

TPU coated membrane based on Nylon fabric, both sides of the product Is coated.

### End Use: Immersion Suits, Buoyancy Compensators, Life Vests

| | Typical | | Typical | |
|---|---|---|---|---|
| Properties | Characteristics | | Characteristics | |
| Test & Method | English | | Metric | |
| Base Fabric | Nylon 210 Den | | Nylon 235 Dtx | |
| | 3.1 | [Oz/yd²] | 105 | [gr/m²] |
| Total Weight | 12.5 | [Oz/yd²] | 430 | [gr/m²] |
| ISO 3801 | | | | |
| Width[s]** | 59, 81 | [inch] | 150, 205 | [cm] |
| Breaking Strength - Strp | 110/103 | [lbs/inch] | 1000/900 | [N/5 cm] |
| ISO 1421 | | | | |
| Tear Strength | 7.7/7.7 | [lbs] | 35/35 | [N] |
| BS 3424 P.5 Me 7B | | | | |
| Coating Adhesion (HF | 16.5/16.5 | [lbs/inch] | 150/150 | [N/5 cm] |
| Welding) | | | | |
| ISO 2411 | | | | |
| Dry | | | | |
| Coating Adhesion (HF | 11/11 | [lbs/inch] | 100/100 | (N/5 cm] |
| Welding) | | | | |
| ISO 2411 | | | | |
| After Hydrolysis (24 | | | | |
| hours @ 3% Saline | | | | |
| Solution) | | | | |
| Cold Crack/Bend | −40° | C. | −40° | C. |
| DIN 53361 | | | | |
| Air Porosity | Pass (10 min at 7 psi) | | Pass (10 min at 7 psi) | |
| B.S 4F 100 Clause 32.1 | | | | |
| Cytotoxicity | 0 | | 0 | |
| ISO 10993-5.209 | | | | |

Another preferred material that may be used for enclosure 15 is also available from Erez, and is known as TPU 2101, which is a lighter weight material than TPU 2012. The specifications for TPU 2101 are as follows:

Product Name: TPU 2101
Polyurethane coated both sides membrane, Nylon fabric.
End Use: Medical & Light weight vest.

| Base Fabric | Nylon 70 Den | | Nylon 78 Dtx | |
|---|---|---|---|---|
| | 1.8 | [Oz/yd²] | 60 | [gr/m²] |
| Total Weight | 10.9 | [Oz/yd²] | 370 | [gr/m²] |
| ASTM D 751 | | | | |
| Total Weight | 10.9 | [Oz/yd²] | 370 | [gr/m²] |
| ISO 3801 | | | | |
| Width[s]** | 59, 81 | [inch] | 150, 205 | [cm] |
| Breaking Strength - Strip | 80/50 | [lbs/inch] | 700/450 | [N/5 cm] |
| ASTM D 751 method B | | | | |
| Elongation | 35/35 [%] | | | |
| ASTM D 751 method B | | | | |
| Tensile Strength | 140/100 | [lbs] | 625/450 | [N] |
| ISO 13934 - 1 | | | | |
| Elongation | 30/40 [%] | | | |
| ISO 13934 - 1 | | | | |
| Tear strength | 2.5/2.0 | [lbs] | 11/9 | [N] |
| ISO 13937 - 2 | | | | |
| Tear strength - Double Rip | 4.8/4.8 | [lbs] | 22/22 | [N] |
| ISO 4674 | | | | |
| Tear strength - Trapezoid | 5/4 | [lbs] | 23/18 | [N] |
| DIN 53363 | | | | |
| Coating Adhesion (HF | 22/22 | [lbs/inch] | 200/200 | [N/5 cm] |
| Welding) | | | | |
| ISO 2411 | | | | |
| Seam Adhesion | 56/45 | [lbs/inch] | 500/400 | [N/5 cm] |
| ASTM F88 & ASTM | | | | |
| D5035 2C-E | | | | |
| Air Porosity | Pass (10 min at 7 psi) | | | |
| B.S. 6F 100 Clause 3.17 | | | | |

While lightweight non-woven materials may be used as the base and enclosure, they are less preferred, as they have a higher weight versus strength ratio, given that a lower-weight/higher-strength combination is preferred here. As the vehicle passes over the base, for example, it should not tear or rupture the base; for this reason, the surface the base sits on should be cleaned of debris, and the driver should not turn the wheels to lessen the chances of abrasion. Care should also be taken not to damages the teeth of the (e.g., plastic) zipper. Further, as the enclosure is placed over the upper portion of the vehicle, it should be designed so as not to tear on items like the rearview mirror, or on the zipper. The use of nylon fabric, preferably coated on both sides with polyurethane, provides a reasonable weight-strength ratio, while polyurethan also provides relatively good abrasion resistance and weatherability, and good coating adhesion, while using few additives. (Additives, such as plasticizers, can migrate over time (such as with PVC, for example), thereby decreasing the effective life span of the material.) Additionally, the materials used here are also useful for the application given that they exhibit relatively robust air porosity (e.g., TPU 2101 can hold 7 psi for 10 minutes, while TPU 2003 can hold 4 psi for 5 minutes with no leakage), while being relatively highly resistant to flex cracking (e.g., TPU 2003 showed no cracks or delamination after 200,000 cycle, soaking 7 days in 2% brine solution).

A base only coated on the lower surface with polyurethane may be used. The use of polyurethane coating is required to allow the heat-softened polyurethane coating on each side of the base and enclosure to be welded to each other (i.e., the side pieces of the enclosure are welded onto the exterior edges of the base). Nylon works well for its high abrasion resistance, but other fabrics, such as synthetic woven fabrics such as polyester scrim, are also envisioned for use as the base and/or enclosure materials. Polyester maintains its properties better in the presence of water than nylon, and also avoids the generation of cyanide gas that nylon exhibits when heated to softening or burning. However, a relatively thin layer of nylon tends not to break/rupture as easily as a layer of polyester of similar thickness.

Tensile strength is one of the basic characteristics of woven fabrics, and is one useful way to measure the material used here. The tensile strength, or the measurement of the force required to pull a material to the point where it breaks (i.e., the point when a material goes from elastic to plastic deformation) is typically measured in both warp (vertical) and weft (horizontal) directions (e.g., 140/100 pounds/in² for TPU 2101, and 275/250 Kg or 606/551 pounds for TPU 2003). Tensile strength is calculated by dividing the peak tension force the material sample in question withstands by its original cross-sectional area. Here, the tensile strength of the materials used is relatively high, while the weight (i.e., 1.8 ounces/yd2 for the lighter TPU 2101 of the enclosure, and 680 grams/m2 (or 20.06 ounces/yd2) for the heavier TPU 2003 of the base) is relatively low.

In another preferred embodiment, the base may be made of woven polyester scrim, 40 oz PVC-coated polyester fabric, with the following product specifications:

| | TEST METHOD | |
|---|---|---|
| BASE FABRIC | | |
| Weight of Base Fabric: | 12 | oz psy |
| Fibre of base Fabric: | Woven polyester scrim | |
| Denier of Fabric: | 2600 | denier |
| Fabric Count: | 15 warp/15 weft | |
| COATED FABRIC | | |
| Overall Weight: | 40 | oz psy |

| | |
|---|---|
| Type of Coating: | PVC (Polyvinyl chloride) |
| Coating Distribution | 60 front/40 back |
| Colour | Yellow, White |
| Width of fabric: | 61″ |
| Sealing Properties: | Dialectric & Thermal |

MECHANICAL PROPERTIES

| Tensile Grab: | 950/900 | | Fed. 191 Method 5100 |
|---|---|---|---|
| Adhesion: | 22 | lb/inch | Fed. 191 Method 5970 |
| Tongue Tear | Warp 150 Weft 150 | | ASTM D751-79 |
| Low Cold Crack: | −40° | C. | Fed 191 Method 5874 |

This material is also mildew and rot resistant, and ultraviolet light resistant.

With the polyester scrim base, the enclosure may be made of a lighter-weight woven polyester scrim, having the following product specifications:

| | TEST METHOD | |
|---|---|---|
| BASE FABRIC | | |
| Base Fabric: | Woven Polyester Scrim | |
| Denier: | 1300/1000 | denier |
| Fabric Count: | 17 warp/18 weft | |
| Base Weight: | 5.2 | oz psy |
| COATED FABRIC | | |
| Overall Weight: | 18.5 | oz psy |

| | |
|---|---|
| Type of Coating: | PVC |
| Coating Distribution: | 40/60 |
| Sealing Properties: | Dialectric & Thermal |
| Color: | Black, Red, Green, Blue, Grey, White, Yellow, |
| | Brown |

MECHANICAL PROPERTIES

| Tensile Strength: | 444 | lbs/441 lbs | ASTM D5035 |
|---|---|---|---|
| Adhesion Strength: | 18 | lbs psi | ASTM D2724 |
| Tongue Tear: | 81 warp/83 weft | | ASTM D2261 |
| Low Cold Crack: | −40° | C. | Fed. Method 5874 |

ROLL PROPERTIES

| | |
|---|---|
| Width: | 61″ |
| Length: | 100 yds, 50 yds |

This material is also mildew and rot resistant, and ultraviolet light resistant.

In the claims, it is recited that the vehicle is driven onto the base, “wherein the base is sufficiently durable to be driven upon by the vehicle without the base tearing or puncturing.” The words “without the base tearing or puncturing” here mean that when the vehicle cover is properly used, as directed, the base will generally not tear or puncture until after an acceptable, predetermined range of usages, although it may eventually wear out over time.

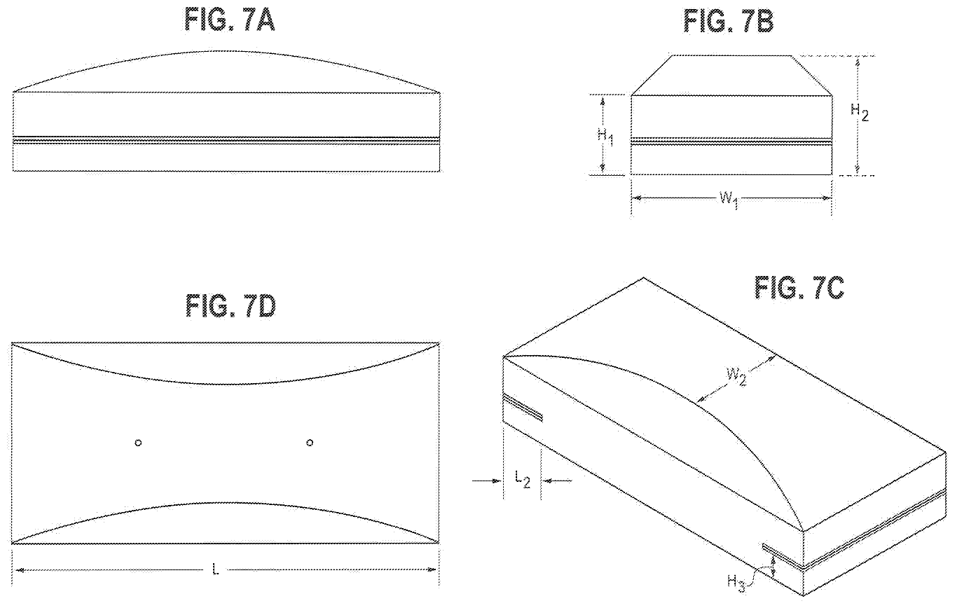

Referring now to FIGS. 7A-7D, another example of the present invention is shown. In this particular, non-limiting example, the cover is generally rectangular, and has a top portion with a uniform bottom base width of 84-inches, that maintains this width for 34-inches in height, and then gradually narrows over the next 17-inches to achieve a top-most base width of 50-inches. The overall height of the cover from the ground is 51-inches in this example. As shown in this example, the length is 180-inches, and the zipper extends around the perimeter of the cover, except that on one side, the zipper only extends 24-inches on each side. The zipper height is 14-inches from the ground. (These dimensions are, of course, non-limiting, and persons of ordinary skill in the art will appreciate that other cover dimensions may be used.)

The current weight of the prototype cover is about 43 pounds. Persons of ordinary skill in the art will appreciate that lighter-duty (e.g., 30-40 pounds) or heavier-duty (e.g., 50 pounds, or more) covers may be used, depending upon the desired application. The inventor envisions that lighter-duty covers weighing about 30-35 pounds may be preferable.

Driving over the zipper may be problematic. For this reason, it is envisioned that a magnetic closure (e.g., FidLock, fidlock.com, based in Hanover, German), which is still waterproof, may be used instead. This might add some weight to the vehicle cover, but might also provide a more reliable closure mechanism.

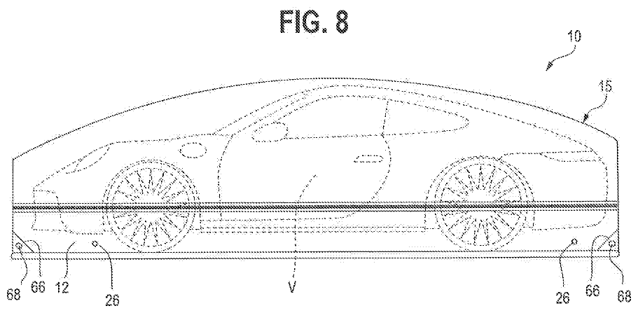

Referring now to FIG. 8, instead of locating the ports at the top of the enclosure, ports 26 may be located (additionally or exclusively) in the base, beneath the front and rear bumper areas. This provides an adjacent open space so that the material does not suck tightly against the vehicle as the interior air is vacuumed from the interior space. Still referring to FIG. 8, in each lower corner where the floor of the base meets the sides of the base, the corners may be welded closed on an angle, as shown at corners 66, creating a robust location for installing a grommet 68 to permit the cover to be tied down to a stable object (e.g., garage foundation, pier, etc.), to prevent the vehicle to float away in the event of a flooding situation.

Persons of ordinary skill in the art will appreciate that other vehicle covers may be employed together with the vehicle cover of the present invention. For example, it may be desired to provide the vehicle with a light cover (such as a “dust cover” or other thin plastic cover) as an extra protection for the vehicle paint, prior to installation of the vehicle cover of the present invention.

The above description is not intended to limit the meaning of the words used in the following claims that define the invention. Persons of ordinary skill in the art will understand that a variety of other designs still falling within the scope of the following claims may be envisioned and used. It is contemplated that these additional examples, as well as future modifications in structure, function, or result to that disclosed here, will exist that are not substantial changes to what is claimed here, and that all such insubstantial changes in what is claimed are intended to be covered by the claims.

I claim:

1. A method for using a vehicle cover, comprising the steps of:
providing a base;
providing a flexible enclosure attached to the base,
driving the vehicle onto the base, wherein the base is sufficiently durable to be driven upon by the vehicle without the base tearing or puncturing;
covering an upper portion of the vehicle with the flexible enclosure; and
completely encapsulating the vehicle in a water resistant manner within the base and the enclosure, by attaching the enclosure to the base.

2. The method of claim 1, wherein the enclosure and the base are sealed using one or more waterproof zippers.

3. The method of claim 1, wherein the enclosure and the base are sealed using a waterproof magnetic closure fastening system.

4. The method of claim 2, further comprising a protective flap covering the one or more waterproof zippers.

5. The method of claim 1, wherein the base and the enclosure are comprised of plastic or fabric.

6. The method of claim 1, further comprising the step of covering at least a portion of the vehicle with a second enclosure, positioned below the vehicle cover, for at least partially covering the vehicle and thereby protecting vehicle paint during encapsulation of the vehicle within the vehicle cover.

7. The method of claim 1, wherein the base and the enclosure are comprised of woven fabric.

8. The method of claim 1, wherein the base and the enclosure are comprised of nylon.

9. The method of claim 1, wherein the base and the enclosure are comprised of nylon with at least one side coated with thermoplastic polyurethane.

10. The method of claim 1, wherein the enclosure or the base, or both, includes one or more one-way air vents, and further comprising the step of using the one or more air vents to remove air from a working volume between the vehicle and the cover, after the vehicle has been sealed within the cover, to achieve a relatively slight negative vacuum, compared to atmosphere, within the working volume.

11. The method of claim 11, wherein the enclosure is capable of holding a positive pressure of air within the working volume for at least about 5 minutes.

12. The method of claim 1, wherein the base has a tensile strength of greater than about 200 pounds/inch in both warp and weft directions.

13. The method of claim 1, wherein the enclosure has a tensile strength of greater than about 100 pounds/inch in both warp and weft directions.

14. The method of claim 1, wherein the total weight of the vehicle cover is less than fifty pounds.

15. The method of claim 1, wherein the total weight of the vehicle cover is less than forty pounds.

16. The method of claim 1, wherein the total weight of the vehicle cover is in the range of about 30-50 pounds.

17. The method of claim 1, wherein the weight of the base is about equal to or less than about 20 ounces/yard².

18. The method of claim 1, wherein the weight of the enclosure is about equal to or less than about 2 ounces/yard².
